(19) United States
(12) Patent Application Publication
(10) Pub. No.: US 2006/0294156 A1
(43) Pub. Date: Dec. 28, 2006

(54) Incremental maintenance of path-expression views

(75) Inventors: Junichi Tatemura, Sunnyvale, CA (US); Arsany Sawires, Goleta, CA (US); Divyakant Agrawal, Goleta, CA (US); Kasim Selcuk Candan, Tempe, AZ (US); Oliver Po, San Jose, CA (US)

Correspondence Address: NEC LABORATORIES AMERICA, INC., 4 INDEPENDENCE WAY, PRINCETON, NJ, 08540, US

(73) Assignee: NEC Laboratories, Inc, Princeton, NJ (US)

(21) Appl. No.: 11/165,960

(22) Filed: Jun. 24, 2005

(51) Int. Cl. G06F 17/30

(52) U.S. Cl. 707/201

(57) ABSTRACT

Systems and methods are disclosed for providing view maintenance by buffering one or more search results in a cache; and incrementally maintaining the search results by analyzing a source data update and updating the cache based on a relevance of the update to the search results.

### BACKGROUND

XML (Extensible Markup Language) is a system for defining, validating, and sharing document formats. XML uses tags to distinguish document structures, and attributes to encode extra document information. The XML semi-structured data model has become the choice both in data and document management systems because of its capability of representing irregular data while keeping the data structure as much as it exists. Thus, XML has become the data model of many of the state-of-the-art technologies such as XML web services. Web service response times have large impacts on the response time of the front-end application since the front-end application may invoke multiple web service operations to serve an end-user request.

Caching data by maintaining materialized views (or query results) has many well-known benefits; one of the major benefits is improving query performance by answering queries from the cache instead of querying the source data. Caching data by maintaining materialized views typically requires updating the cache appropriately to reflect dynamic source updates. To be useful, a materialized view needs to be continuously maintained to reflect dynamic source updates. The problem of efficient incremental view maintenance has been addressed extensively in the context of relational data models but only few works have addressed it in the context of semi-structured data models.

Current web services caching approaches, e.g. the approach of Microsoft's .NET framework, follow a time-based invalidation scheme in which the cached results are invalidated after a pre-specified time period (life time). The drawbacks of such a scheme are: (1) the cached results are likely to be over-invalidated since the invalidation process does not take into account the relevance of the source updates to the cached results, (2) the invalidation operation implies recomputing the views whenever they are required again; this recomputation process is generally an expensive one, and (3) the “freshness” of the cached results is not guaranteed because source updates may take place just after a result has been cached, the effect of these updates will not be reflected in the cache before the lifetime of the cache expires. This might be inappropriate for critical applications which require a high level of consistency between the source and the cache.

The XML views maintained at the cache are assumed to be the results of certain queries (view specifications) issued against a source XML document. The W3C consortium is currently working towards standardizing XPath and XQuery as XML query and view specification languages. Path expressions form the core of the XPath and XQuery languages: they are the language constructs which are used to select and retrieve data from XML data sources. The retrieved data can be manipulated by other language constructs to form the final XML query result. Therefore, caching the results of path expressions could be potentially beneficial to answer general XML queries efficiently.

Generally, in order to maintain cached views, a maintenance algorithm needs to issue queries to the data source; querying the source is generally an expensive operation in terms of time and processing since the data source is usually huge in size. Conventional techniques for providing incremental view maintenance for structured data such as XML data is inapplicable to Web service caching and many other practical use cases due to the following limitations: (1) view specification models and source update models are very limited, (2) amount of additional data stored for maintenance (intermediate results) can be arbitrarily large regardless of the size of cached view results.

### SUMMARY

Systems and methods are disclosed for providing view maintenance by buffering one or more search results in a cache; and incrementally maintaining the search results by analyzing a source data update and updating the cache based on a relevance of the update to the search results.

Advantages of the system may include one or more of the following. The system provides incremental maintenance of views defined over XML documents using path expressions. The system minimizes the number and the size of the source queries which are used to maintain the cached results. The incremental view maintenance updates cached views to reflect source updates without a full recomputation of views. As a result, the system provides solutions for fast, scalable management of update management of distributed content with interdependency. The system also enables efficient Web service cache management that addresses performance issues of Web services. The solutions can be applied to other XML content dependency management applications such as: (1) XML content delivery including RSS dissemination (2) scalable configuration management of distributed systems (such as grid applications) through change dependency monitoring.

Other advantages can be as follows. The view specification language is powerful and standardized enough to be used in realistic applications. The size of the auxiliary data maintained with the views is upper bounded; it depends on the expression size and the answer size regardless of the source data size. The system does not require a source schema—the source data can be any general well-formed XML document. Moreover, the system off-loads processing from the back-end application to provide web services scalability. Thus, maintaining XML views is an integral problem that needs to be handled efficiently. Further, the view definitions are not restricted to monotonic. That is, the system handles cases where an addition in the source could result in addition or deletion in the view. Similarly, we handle cases where a deletion in the source could result in addition or deletion in the view.

The system also preserves the privacy of the data source; it is not required that the definitions of the expression predicates be disclosed for the maintenance algorithm to do its job. Only the expression axis and label tests are required. The predicate definitions might include any proprietary user defined functions. This privacy-preserving property is essential for web service caching projects where the web service provider might not be willing to disclose all the details of the view definitions (web service operations) to a third-party that is caching the web service responses.

### BRIEF DESCRIPTION OF THE DRAWINGS

FIG. 1 shows a block diagram of an exemplary system that provides incremental maintenance of path-expression views.

FIG. 2 shows an exemplary XML document represented as an ordered tree.

FIG. 3 shows an exemplary process for performing incremental maintenance.

FIG. 4 shows a second exemplary process for performing incremental maintenance.

FIGS. 5A, 5B, 6A and 6B show various performance comparisons for updating path expression views.

FIG. 7 shows an exemplary XML tree illustrating an incremental maintenance example.

### DESCRIPTION

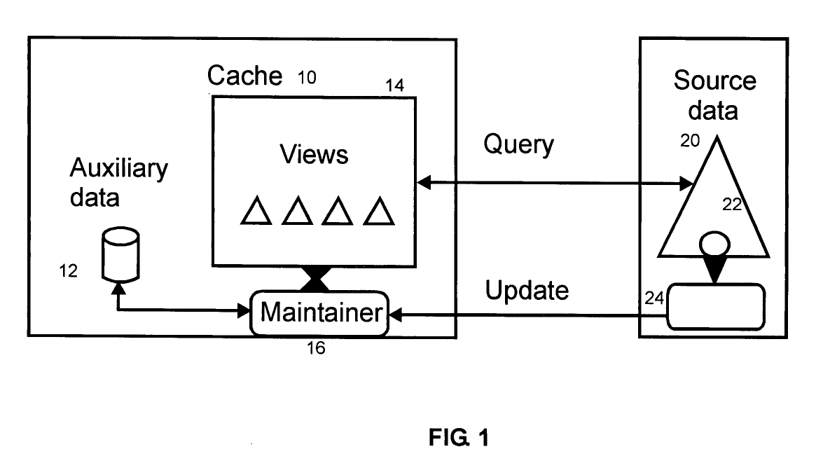

FIG. 1 shows a block diagram of an exemplary system that provides incremental maintenance of path-expression views. The system has a cache 10 and a source data system 20. The cache 10 includes an auxiliary database 12 which communicates with a cache maintainer 16. The maintainer 16 provides a plurality of views 14 or search results.

The source data system 20 includes data 22, which is structured data such as XML data as well as an update engine 24 that updates the maintainer 16. A search query would access the cached views 14 if the cached data provides a current response. Alternatively, the query would access the source data 22 to formulate an answer to the query.

In one embodiment, the data 22 contains documents that conform to the Extensible Markup Language. The data uses tags (for example <em>emphasis</em> for emphasis), to distinguish document structures, and attributes (for example, in <A HREF=“http://www.xml.com/”>, HREF is the attribute name, and http://www.xml.com/ is the attribute value) to encode extra document information.

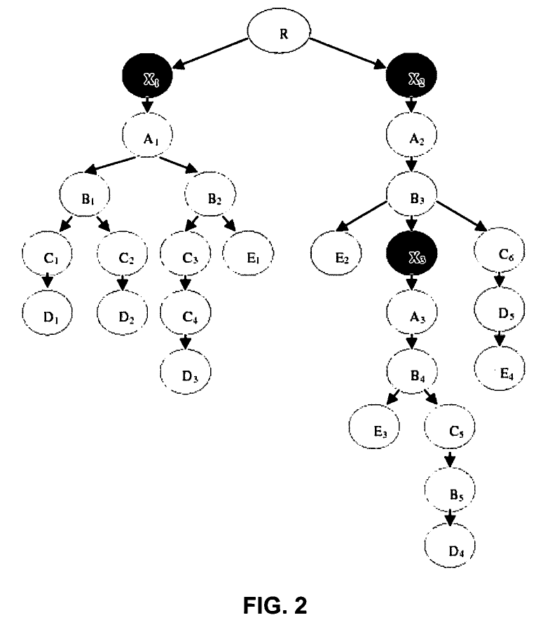

FIG. 2 shows an exemplary XML document represented as an ordered tree in which every node n is a pair <n.id, n.label> where n.id is a node identifier that uniquely identifies the node among all the nodes in the XML tree and n.label is a string that describes the node type and value. Upper-case letters represent the node labels. For example, A, B, and C are node labels and numeric subscripts are used to distinguish different nodes that have the same label. Thus, Aᵢ and Aⱼ refer to two distinct nodes with the same label A.

The pictorial illustration of FIG. 2 is used to capture the ancestor and descendent relationships among the nodes, and the tree order is from left to right in FIG. 2. Typically, the node identifier has the following properties:
1. Dynamic; i.e. adding and deleting nodes in the source tree do not require reassignment of node identifiers as the property preserves the source node identities;
2. Reflecting the document order; i.e. given the identifiers of any two nodes nᵢ and nⱼ, it can be determined if nᵢ is before or after nⱼ in the preorder traversal of the source tree. This property is required to keep the order of nodes in the cached view in correspondence with the original document order of nodes; and
3. Reflecting the containment relationships among the nodes; i.e. given the identifiers of two nodes nᵢ and nⱼ, it can be determined if nᵢ and nⱼ have ancestor or descendant relationship. This property is used by XML query processors.

The label has the following properties:
if n corresponds to an XML element then label represents the element name;
if n corresponds to an XML attribute then label represents the attribute name; and
if n corresponds to a value of any type then label is the value representation, hence it may have types associated with it.

Based on the definition of node labels, a selection condition in a query involving the node name, kind, or type is represented as a label test. For example, a condition that retrieves ‘book’ elements is a label test and a condition that retrieves nodes storing values greater than 5 is also a label test. A label test could also be the wildcard character “*” which matches all labels.

The XML tree of FIG. 2 can be updated to reflect updates to the source XML document. In this context, a source update is a transformation of the source XML document. Although the transformation could be in the form of changes to the leaf nodes as well as internal nodes in the tree, one embodiment works with primitive transformations that operate at the level of the leaf nodes in an XML tree. Any arbitrary transformation to the source tree, e.g. adding or deleting a sub-tree from the source, can be expressed in terms of the following two primitive operations: (1) Add a leaf node, and (2) Delete a leaf node. More formally, an update U is a pair <U.type, U.path> where U type is the type of the update: Add (add a leaf node) or Delete (delete a leaf node). U.path is the path of all the ancestors of the added or deleted node starting with the document root and ending with the added or deleted node itself. Each node in U.path is given by both its label and its identifier. The added or deleted node is referred to as U.node. For example, U=<Add, (R, X₁, A₁, B₁, Z)> represents the addition of node Z as a child node of node B1 in the XML document shown in FIG. 2.

Path expressions are the basic building blocks of XML queries. A path expression E of size N is a sequence of N steps: (s₁, s₂, . . . s_{N}). A step sᵢ is a triple <sᵢ.axis, sᵢ.label, sᵢ.pred> where:
sᵢ.axis is an axis test; it is either a child selector (denoted by ‘/’) or a descendant selector (denoted by ‘//’). The axis test selects nodes based on the tree structure.
sᵢ.label is a label test; it selects some of the nodes that passed the axis test. The label test is evaluated by examining only the node label without examining any other nodes or structures in the tree.
sᵢ.pred is a predicate test; it further filters the nodes that have passed both the axis test and the label test. Unlike the label test, the predicate test can be any complex condition examining the labels and the structure of the nodes in the sub-tree of the node being tested. A predicate can use aggregate functions, user defined functions, operators, quantifiers, for example.

The first sᵢ processing starts at a pre-specified sequence of nodes in the source tree called the expression context C. Given an expression E, a document tree D, and a sequence of context nodes C (a sequence of some of the nodes of D), a query, Q, denoted as Q=q(E, C, D) returns a sequence of nodes R as a result. Conceptually, the execution of sᵢ (i>1) starts at the sequence outputted from executing sᵢ₋₁. The intermediate result of step sᵢ (1<i<N) as Rᵢ=q(sᵢ, Rᵢ₋₁, D), R₀=C.

Every Rᵢ, (1<i<N) is a sequence of nodes ordered by the document order. The final result R is defined as the result of the last operation; i.e. R=R_{N}.

For example, consider the query Q=q(E, C, D) where: D is the document tree of FIG. 2, C=(X₁, X₂, X₃), and the steps of E are specified as follows:

s₁=/A

s₂=//B [Count (//E)>1 OR Count(/D)>1]

s₃=//C [Count (//E)=0]

s₄=//D

In this query, the first step s₁ starts at every node in C and selects all children with label A; this results in R₁=(A₁, A₂, A₃). Then s₂ starts at every node in R₁ and selects all the descendants with label B that have at least one descendant labeled E or at least one child labeled D; this results in R₂=(B₂, B₃, B₄, B₅). Starting at R₂, step s₃ selects all the descendants labeled C that have no descendants labeled E; this results in R₃=(C₃, C₄, C₅, C₅). Finally, s₄ starts at R₃ and selects all the descendants labeled D. Hence, the final result of Q is R=R₄=(D₃, D₃, D₄, D₄).

A node can be duplicated in the answer of any step. This shows the possibilities of multi-derivations in path expression views. Multiple occurrences of the same node in a sequence are differentiated by using a numeric superscript. For example, the result R is denoted as R=(D₃¹, D₃², D₄¹, D₉²).

The incremental maintenance process uses the following definitions regarding path expressions:
1) Predᵢ(n) is true if and only if sᵢ.pred evaluates to true at node n. For example, Pred₃(C₁) in the example query above is true because C₁ satisfies the condition s₃.pred=[Count(//E)=0] since C₁ has no descendants labeled E.
2) The Result Path of a node n in the result R, referred to as ResultPath(n), is the sub-sequence (may be noncontiguous) of the ancestors of n (including n) that matched the steps of E and thus caused n to appear in R. In the example query above, ResultPath(D₃¹)=(X₁, A₁, B₂, C₃, D₃) and ResultPath(D₃²)=(X₁, A₁, B₂, C₄, D₃). The result paths have the same size, which is equal to N+1, where N is the expression size. This is because every element in a result path matches exactly one step of E and every step of E is matched by exactly one element in each result path; the extra 1 is because the first node in each path result is a context node from the sequence C which is not matching any step.
3) For every node n such that nεR, we define ResultPathᵢ(n), i>0 as the i-th element in the result path of n. By this definition,
∀nεR, ResultPath₀(n)εC, ResultPath_{N}(n)=n.

In one embodiment, certain simplification/restrictions are maintained to achieve an efficient view maintenance. First, only child and descendant axes are handled in the axis test as the child and descendant axes are the most commonly used axes in practice. The other axis types, such as parent and ancestor, are not handled. Second, a Predicate can examine only the subtree of the node being tested. In other words: Predᵢ(n), for all i, is exclusively evaluated by examining the subtree rooted at n. This simplification is based on the fact that a node in an XML document is semantically described by its descendants, and thus selecting a node should depend on its label and its descendants. With this approach, predicate evaluation can only be done at the source XML data. The benefit is that the predicates can be arbitrarily complex and the predicates can preserve the privacy/security of the XML data source.

To illustrate an update, the result R of an example expression E is cached at the client site and subsequently the following update takes place at the source tree of FIG. 2: U=<Add, (R, X₁, A₁, B₁, E₅)>. The effect of this update is to change Pred₂(B₁) from false to true. The direct effect of this change on the evaluation process of E is to add B₁ to the intermediate result R₂. Since there is a new node added to R₂, there is a possibility that this addition can induce other indirect additions in the subsequent intermediate results Rᵢ, i>2. This is indeed the case in this scenario since nodes C₁ and C₃ would now qualify to be in R₃ as descendants of B₁. Moreover, the inclusion of C₁ and C₃ causes D₁ and D₂ to be added to R₄, i.e. to the cached result R. This illustrates that an update U can affect the final results R by impacting any of the intermediate result Rᵢ.

In this example, U changed Predᵢ(n) for only one node (n=Bᵢ) and one value of i (i=2). This change effectively added B₁ to R₂. Consequently, other nodes were added to other intermediate results but without U changing any more predicates; these are nodes C₁, C₂, D₁, and D₂ in the example. Thus, an update U causes a node n to be added to an intermediate result Rᵢ under one of two possible scenarios:

1. U changes Predᵢ(n) from false to true,

2. U does not affect Predᵢ(n).

The first case is a direct addition and to the second case is an indirect addition because it is caused indirectly through a direct addition. Direct deletion can occur when U changes Predᵢ(n) from true to false causing n to be deleted from Rᵢ. Indirect deletion can occur when n is deleted from Rᵢ without U affecting Predᵢ(n). For example, if U=<Add, (R, X₁, A₁, B₂, C₃, E₆)> then U directly deletes C₃ from R₃ because it changes Pred₃(C₃) from true to false. This direct deletion induces the indirect deletion of the first occurrence of D₃ from R.

In the following discussion, δᵢ⁺ denotes the sequence of all nodes that U directly adds to Rᵢ; δᵢ⁻ denotes the sequence of all nodes that U directly deletes from Rᵢ, and δᵢ=δᵢ⁺|_|δᵢ⁻. Each of δᵢ⁺ and δᵢ⁻ could have repetition due to multi-derivation possibilities and that δᵢ⁺ and δᵢ⁻ are mutually disjoint because a node n can not be directly added to and deleted from Rᵢ at the same time; that is because U can not change Predᵢ(n) from false to true and from true to false at the same time.

Since any indirect addition or deletion is originated by a direct one, an embodiment of the maintenance process determines all direct additions and deletions at Rᵢ and then determines the indirect effects that are induced by the direct effects. Ultimately the process determines indirect effects on the cached result R. The indirect effects on all the intermediate results Rᵢ, i<N are not required per se, but they can be used to discover the final effects on R.

To discover indirect effects from the direct ones, the process handles two cases:

1. When a node n is directly added to Rᵢ, then the maintenance algorithm has to issue a query to the source to determine the indirect additions that might happen due to this direct addition. For example, when B₁ is added to R₂, the indirectly added nodes C₁, C₂, D₁, and D₂ can not be retrieved without querying the source because they had no existence at the cache before U occurred. In general, when a node n is directly added to Rᵢ then, in order to retrieve the indirect additions at all Rⱼ, j>i, the maintenance process needs to issue a source query with context as the singleton sequence (n) and with the steps sequence (sᵢ₊₁, sᵢ₊₂, . . . s_{N}). The query is denoted as: q((sᵢ₊₁, sᵢ₊₂, . . . s_{N}), (n), D).

2. When a node n is directly deleted from Rᵢ, then the nodes of R that came to R because n used to belong to Rᵢ are deleted from Rᵢ. In other words, all the nodes r of Rᵢ that have ResultPathᵢ(r)=n are deleted from R. In the example, the direct deletion of C₃ from R₃ results in deleting D₃¹ from R because ResultPath₃(D₃¹)=C₃.

Once result path of each node of R is known, the process discovers the necessary indirect deletions from R without issuing any source queries. The system thus keeps with every node nεR the result path ResultPath(n).

The collection of all the result paths is kept as auxiliary data which is not itself a target, but it is just used to achieve efficient incremental maintenance of the cached result R. In one embodiment, this is the only auxiliary data used. No two result paths are the same; even if a single node from the source tree occurs multiple times in R, each occurrence will be associated with a different result path.

The keeping of the result paths is not equivalent to keeping all the intermediate results Rᵢs. In particular, if a node n in Rᵢ does not lead to a node in R then the process does not keep n in the auxiliary data. For example, in the example

/A//B[Count(//E)≧1 OR Count(/D)≧1]//C[Count(//E)=]//D
B₅ is in R₂. However, B₅ did not lead to any node in R because none of its descendants were qualified to be in R₃ or R₄. Thus, B₅ is not kept in the auxiliary data. Obviously, the number of such nodes like B₅ can be arbitrarily large in the source tree without any bound.

The size of the auxiliary data is bounded regardless of the source tree. To compute this size, since each result path is of length N+1 and M is the size of the cached result R, then the size of the auxiliary data is O(M * N). The process stores only the node IDs in the result paths and the node labels are not needed. This limits the size of the auxiliary data because the node ids are machine generated as compact codes.

The determination of the direct effects is discussed next. This determination is done in two phases for every Rᵢ: 1) the Axis&Label test and 2) the Predicates test.

(1) The Axis & Label Test. For every Rᵢ, the sequence of direct effects δᵢ is determined by querying the source because it might involve predicate evaluations to determine the nodes n for which Predᵢ(n) has changed due to U. Since the amount of source queries is to be minimized, the Axis & Label phase identifies a sequence Δᵢ such that, without any source queries, that δᵢ⊂Δᵢ. In the Predicates Test phase, Δᵢ is further filtered by predicates evaluations to identify the exact sequence δᵢ. In other words, the Axis & Label Test works as a first-level filter for identifying δᵢ since every node n in δᵢ also belongs to U.path. In other words, if, due to U, a node n belongs to δᵢ for any i, then n must also belong to U.path. This limits the search space to the nodes in U.path.

Although U.path has all the information needed to conduct the axes and labels tests needed to identify δᵢ, it does not have enough information to evaluate the predicates at any of its nodes n because a predicate can refer to any node in the subtree of n. The process applies the Axes and Label tests to U.path, ignoring the predicates tests. The result is the sequence Δᵢ which is a super-sequence of δᵢ.

Computing the different Δᵢ's proceeds similar to computing the intermediate results Rᵢ's of the original view specification query except that the latter selects from the source tree D while the former selects from the single branch U.path. Any node n in any δᵢ must have a node of the expression context C as an ancestor. Thus, the process initializes Δ₀ to be all the context nodes that exist in U.path, i.e. Δ₀=C∩U.path. After this initialization, the process determines Δᵢ (for i>1) as all the nodes in U.path that satisfy sᵢ.axis and sᵢ.label starting at nodes in Δᵢ. This query is denoted as Δᵢ=q(sᵢ.axis&label, Δᵢ₋₁,U.path).

The following example shows the computation of the Δᵢs. In an update U of adding a node D₆ as a child of D₄, U.path is the tree branch that starts with the root R and ends with D₆. Computing the different Δᵢ's as described above results in: Δ₀=(X₂, X₃), Δ₁=(A₂, A₃), Δ₂=(B₃, B₄, B₅), Δ₃=(C₅, C₅), Δ₄=(D₄, D₄, D₆, D₆).

Δᵢ is a supersequence of δᵢ: there are nodes in Δᵢ that are not directly added to or deleted from Rᵢ. For the example shown above, using the predicates as defined in the example path expression, the only nodes that will be directly added are the two occurrences of D₆ that appear in Δ₄. The other nodes n in all the computed Δᵢ's will not be added or deleted because U did not affect Predᵢ(n). Note that because D₆ did not exist before U occurred, the value of Predᵢ(D₆), for all i is false before U occurred. The same holds with deletion updates: if an update U deletes a node n from the source tree, the value of Predᵢ(n) is false after U occurred.

(2) The Predicate Test. The Predicate Test identifies the sequence δᵢ from the sequence Δᵢ. To accomplish this task, the process determines which nodes n in Δᵢ had their Predᵢ(n) changed due to U. To detect such changes, the process compares, for every node, the values of Predᵢ(n) before and after U occurred. The value before U occurred is referred to as Predᵢ^{before}(n) and to the value after U occurred as Predᵢ^{after}(n). Nodes for which Predᵢ^{after}(n) are excluded because they are not affected by U. Nodes with their Predᵢ(n) changing due to U are directly added to or deleted from Rᵢ.

The determination of the values of Predᵢ^{after}(n) and Predᵢ^{before}(n) for every node n in Δᵢ is as follows. The value of Predᵢ^{after}(n) is computed simply by querying the source. This query, in general, will be processed very quickly as it just evaluates the predicate sᵢ.pred at node n in the source tree D. the returned value is true or false. We denote this query as: pred_{q}(sᵢ.pred, (n), D).

The query is performed by a source query processor with the following benefits:

1. The process does not need to keep any auxiliary data that might be needed to evaluate complex predicates—if data from all nodes is stored to evaluate every predicate, then the size of the auxiliary data can be unbounded.
2. The source privacy is protected by not revealing the predicate definitions. A predicate definition may use proprietary functions that the data provider is not willing to disclose as in the case of web service providers.

The value of Predᵢ^{before}(n) cannot be computed by a source query because the update U has already been incorporated at the source. Instead, the value of Predᵢ^{before}(n) is deduced as follows: if node n appears as the i-th element in the result path of any node in R then this implies that n was qualified for Rᵢ before U occurred; hence, Predᵢ^{before}(n)=true. Let RPᵢ(n) be true if and only if n is the i-th element of the result path of any node in R, then RPᵢ(n)=>Predᵢ^{before}(n). This shows how the auxiliary data—which was originally intended to be used for discovering indirect deletions—could help in the predicate test as well. However, if RPᵢ(n) is false then the value of Predᵢ^{before}(n) cannot be determined because it may be false or true. Thus, if RPᵢ(n) is false, there is an ambiguity about the value of Predᵢ^{before}(n).

One implementation to resolve this situation includes in the auxiliary data all the nodes that qualify to be in any intermediate result Rᵢ instead of only including those nodes that actually lead to nodes in the final result R. However, the size of the auxiliary data can become unbounded. In another implementation, the ambiguity is resolved by simply assuming that Predᵢ^{before}(n) is false. This assumption does not affect the result of discovering the indirect effects in R.

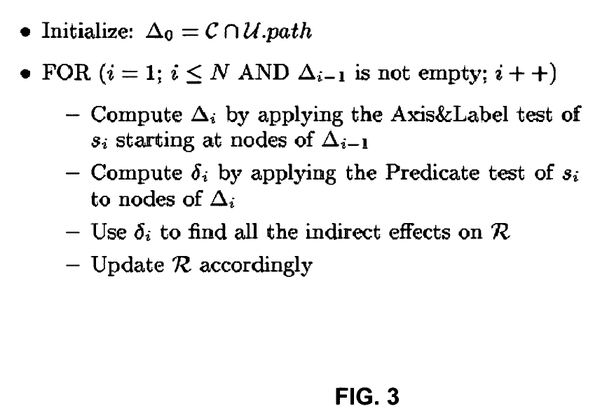

FIG. 3 shows one embodiment of the process for view maintenance of XML path expressions. The maintenance process combines the two phases described above to determine the direct effects at every Rᵢ and uses the determined direct effects to discover the ultimate effects on the cached result R. The process is as follows:

```
Initialize: Δ₀ = C ∩ U.path
FOR (i=1; i ≦ N AND Δᵢ₋₁ is not empty; i++)
    Compute Δᵢ by applying the Axis & Label test of sᵢ starting at
    nodes of Δᵢ₋₁
    Compute δᵢ by applying the Predicates test of sᵢ to nodes of Δᵢ
    Use δᵢ to find all the indirect effects on R
    Update R accordingly
```

In the first step of the loop, every Δᵢ is computed from Δᵢ₋₁. One implementation improves performance by excluding some nodes from Δᵢ₋₁ before moving on to the computation of Δᵢ in the next loop iteration. This will result in a smaller Δᵢ and hence in improved performance. The sequence achieved by reducing Δᵢ is referred to as Λᵢ. Hence, in order to discover all the ultimate effects on R, the process only needs to start each iteration i only at the nodes n of the previous iteration for which the value of Predᵢ₋₁(n) is true before and after U occurred. In other words, the process takes only the nodes n that have RPᵢ₋₁(n)=Predᵢ^{after}(n)=true.

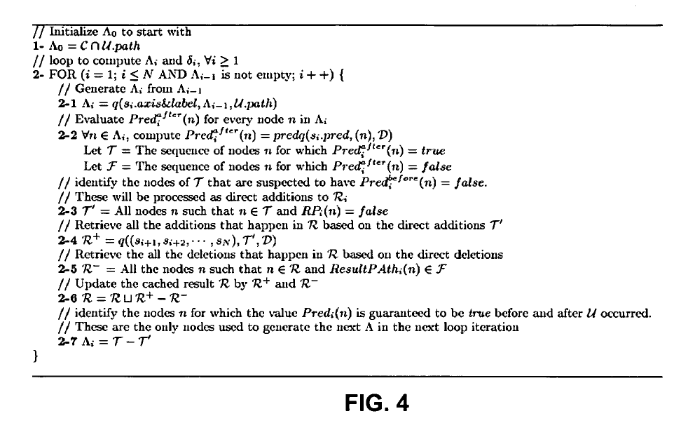

FIG. 4 shows another embodiment of the incremental view maintenance process. This process computes and uses the reduced sequences Λᵢs instead of the Δᵢs. For the initialization of Λ₀ and Λ₁, it is more programmatically convenient to implement the reduction step at the end of each iteration instead of the beginning; step 2-7 in the process computes the reduced Λᵢ to be used directly by step 2-1 of the following iteration.

Step 2-2 issues small source queries to evaluate Predᵢ^{after}(n) for every node n in Λᵢ. According to the results of these queries, Λᵢ is partitioned into the two disjoint sequences T and F. Then, step 2-3 identifies the nodes of T that will be considered as direct additions at Rᵢ.

The sequences of nodes to be added to/deleted from R due to the direct effects at every iteration as R⁺/R⁻,respectively. These sequences are computed by steps 2-4 and 2-5 respectively. Conforming to the process of discovering indirect effects, step 2-4 issues a source query while step 2-5 only uses the auxiliary data. Instead of issuing a separate source query for every direct addition, step 2-4 uses a single query with a combined context sequence which incorporates all the direct additions at one shot, this should perform better than issuing many queries.

Finally, step 2-6 updates R by incorporating the nodes of R⁺ and R⁻. The maintenance process needs to maintain the auxiliary data as well as the cached result R. For every node n removed from R, ResultPath(n) is removed from the auxiliary data; and for every node n added to R, ResultPath(n) is added to the auxiliary data. Computing the result paths requires some cooperation from the source query processor: the query processor should return with every node n in the answer of the query in step 2-4 its result path ResultPath′(n). This result path is a partial path of length N−i<N because the query in step 2-4 uses only steps sᵢ₊₁, sᵢ₊₂, . . . , s_{N} of the original expression. Thus, to get the full result path ResultPath(n), the process concatenates ResultPath′(n) to the right end of a second result path of length i. This second path is the one which led from a node in the original expression context C to the first node in ResultPath′(n); it can be found by tracing the sequences Λ₀, Λ₁, . . . Λᵢ through the iterations 1, 2, . . . , i. For clarity of the presentation, this secondary process of maintaining the auxiliary data is not shown in the process of FIG. 4.

The process of FIG. 4 issues several source queries; however, the processing of these queries is computationally much less expensive than the alternative of issuing the original view specification language. The reason is that these queries are much smaller regarding theirs sizes and contexts than the original view specification query. This advantage of incremental maintenance over full recomputation is illustrated by the following tests.

In the tests, the system maintains one cached object (such as an XPath query result) and processes node updates one by one. For each update, the time required for incremental maintenance is compared with the time required for the full view recomputation.

The XMARK benchmark was used to generate source documents with two data sets of different sizes: Data set 1 (325236 nodes), and Data set 2 (1281843 nodes).

The XML data source was implemented using a relational database. The node ids were generated based on the OrdPATH scheme. Each node was represented as a row of a table with the following columns {id, type, label, value, parent_id} where id is a node identifier and type is a node type (element, attribute, or value). When type is “element”, label represents the element name. When type is “attribute”, label represents the attribute name, and value represents the attribute value. When type is “value”, value represents the data value. Although an OrdPATH node id contains information about the id of the parent node, a column parent-id is used to represent the ID of the parent for performance optimization. The tests were done using an Oracle 9i database on a PC with Linux 8.0, Pentium 4 1800 MHz CPU, and 1 GB memory.

The following two XPath queries were used:

```
XPath Query 1:
    /site/people/person [like (@id,“person2%”)]/name/text ( )
XPath Query 2:
    /site/people [person [like (@id,“person1%”)]]/
```

person[like(@id, “person2%”)]/name/text( )

where “like” is a boolean predicate that corresponds to SQL's “like” operator.

The XPath Query 1 is implemented as the following SQL join query:

SELECT DISTINCT f.id
FROM x a, x b, x c, x d, x e, x f
WHERE a.type = “element” and a.label = “site”
and a.parent_id = “0” and b.type = “element”
and b.label = “people” and b.parent_id = a.id
and c.type = “element” and c.label = “person”
and c.parent_id = b.id and d.type = “attribute”
and d.label = “id” and d.value like “person2%”
and d.parent_id = c.id and e.type = “element”
and e.label = “name” and e.parent_id = c.id
and f.type = “value” and f.parent_id = e.id;

where “x” is the name of the table that contains the source nodes. Similarly, the XPath Query 2 is also implemented as a join query. The Predicate test query for the XPath query 1 is implemented as the following SQL query:

SELECT *
FROM x c, x d
WHERE c.id = ?
and d.type = “attribute” and d.label = “id”
and d.value like “person2%” and d.parent_id = c.id;

where ‘?’ represents a context node.

For each data set and query pair, 100 source updates were randomly generated. An average of results for full query verses incremental maintenance is as follows:

| | Data set 1 | | Data set 2 | |
|---|---|---|---|---|
| | Query 1 | Query 2 | Query 1 | Query 2 |
| Full query (msec) | 1459.61 | 4412.2 | 6549.28 | 83066.25 |
| Maintenance (msec) | 134.13 | 237.01 | 355.3 | 1108.11 |

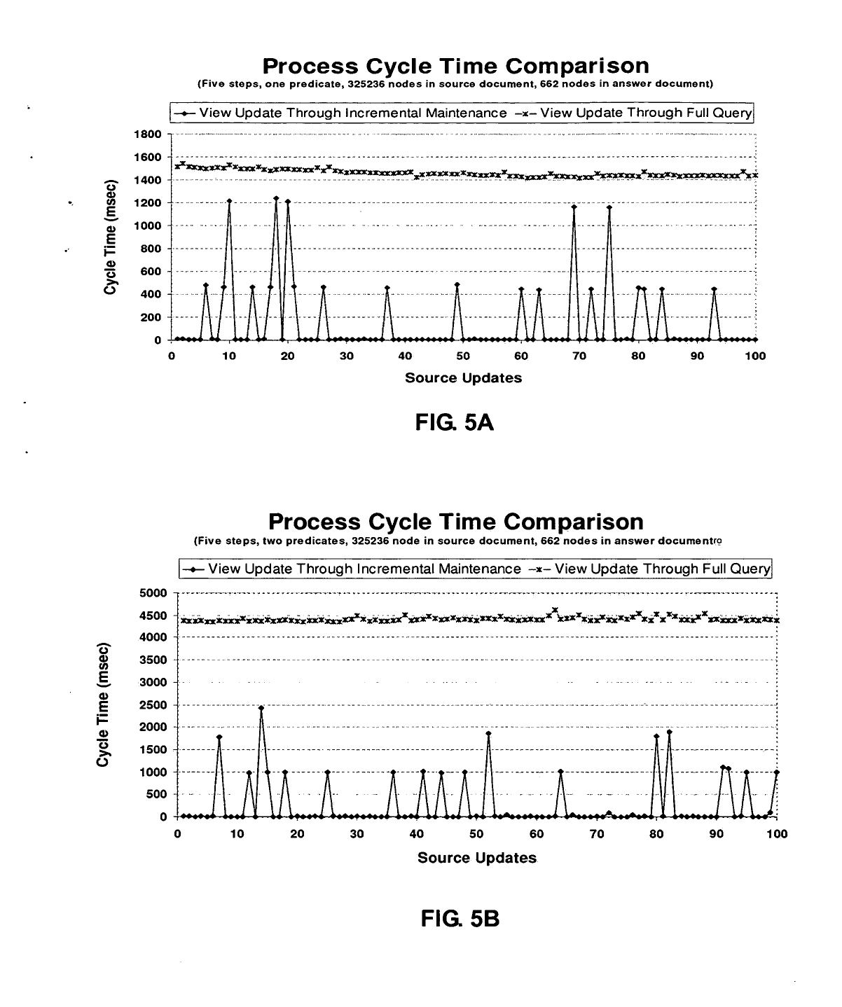

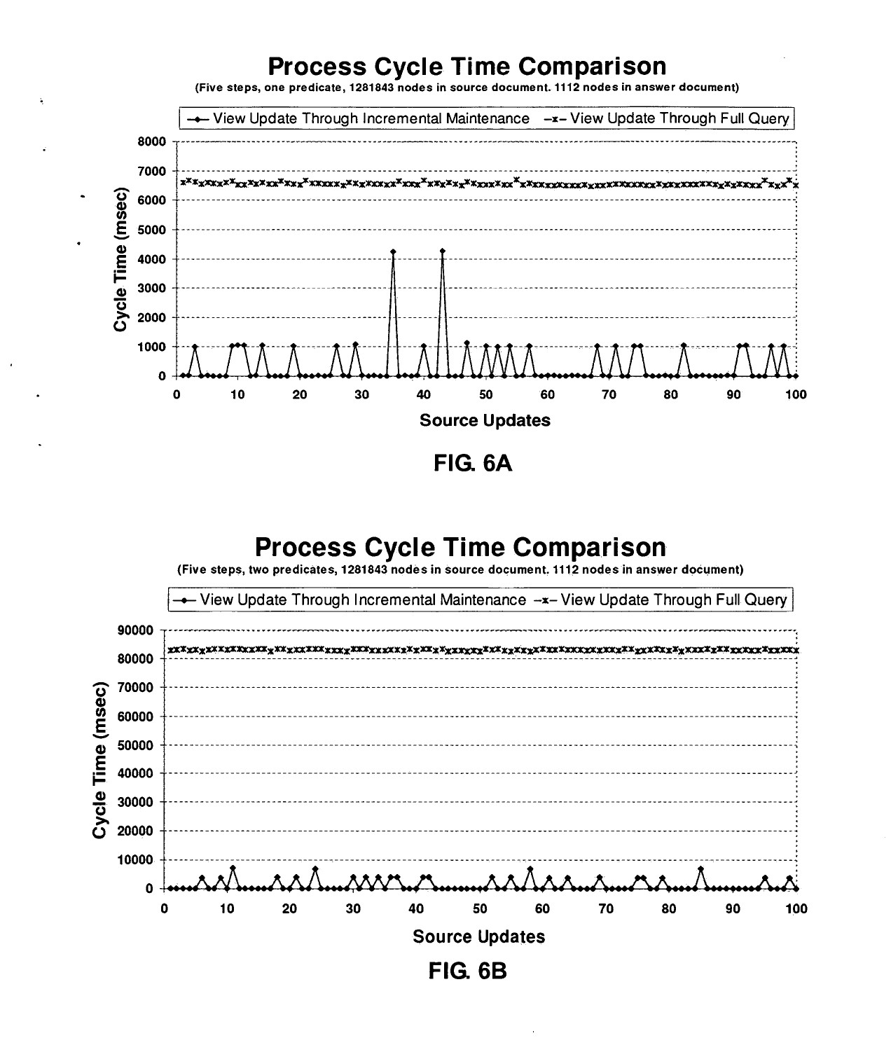

The results of the time comparison for all the updates are shown in FIGS. 5A, 5B, 6A and 6B. These figures show the advantage of incremental view maintenance approach. For example, for the second data set and second query, the full query takes 80 times longer to execute. The results show that the view maintenance process scales well with both data size and query complexity: the improvement for the smaller data set, less complex query pair (Data set 1, Query 1) is 10X while for the larger data set, more complex query pair (Data set 2, Query 2) the improvement is boosted 80X. The figures show that some updates have taken almost no time to be maintained while other updates have taken a relatively significant time. This is because the former class of updates either do not affect the view result or they cause only deletions at the view results; recall that deletions are processed using the auxiliary data without any source queries. The latter class of updates causes additions at the view and requires more processing time because it requires querying the source.

The supported view specification language of path expressions is powerful for many applications. The size of the auxiliary data used in bounded as O(M * N) where M is the size of the cached result and N is the size of the view specification expression. The size of the auxiliary data is compact and does not exceed this bound regardless of the complexity of the source XML tree and regardless of the complexity of the predicates used in the view specification path expression. The process delegates any predicate evaluation to the source query processor; the benefits of this delegation are two-fold (1) No auxiliary data is kept for the evaluation of predicates; without this delegation, the size of the auxiliary data can not be bounded. (2) The privacy of the predicate definitions is preserved since the cache manager need not know such definitions in order to maintain the views. This property is useful when the predicate definitions include proprietary functions that the data provider is not willing to reveal, for example, an XML web service provider would be able to use the XML caching system without disclosing its complex predicate definitions. The process does not depend on any schemas for the source XML document, it can handle any general XML document. Regarding the efficiency of the maintenance process, the experimental results show that incrementally maintaining path expression views using the approach presented here is much faster than maintaining the views by recomputing the view specification query.

One embodiment of the view maintenance process is written as the following code:

```
NodeSet maintenance(NodeSet result, Expression e, NodeSet context,
              Update u, Document d, ResultPath rp) {
  NodeSet r_plus = new NodeSet( ); // additions to the result
  NodeSet r_minus = new NodeSet( ); // deletions to the result
  NodeSet candidates = context.intersection(u); // C₀
  // check each step of the expression
  for(int i = 1; i <= e.size( ) && candidates.size( ) > 0; i++) {
    // find candidates of direct addition/deletion at the step i
    candidates = q(e.step(i).axis_label, candidates, u); // Cᵢ
    NodeSet addition = new NodeSet( ); // direct addition
    NodeSet deletion = new NodeSet( ); // direct deletion
    NodeSet candidate1 = new NodeSet( );
  // check predicates for each candidate
  foreach Node n in candidates {
    boolean pred_before = predBefore(n,e,i,d,rp); // Predᵢ^{before}(n)
    boolean pred_after = predAfter(n,e,i,d,rp); // Predᵢ^{after}(n)
    if(pred_before == false && pred_afer == true) {
      addition.add(node);
    } else if (pred_before == true && pred_after == false) {
      deletion.add(node);
    } else if (pred_before == true && pred_after == true) {
      candidate1.add(node);
    }
  } // now we have Addᵢ(addition), Delᵢ(deletion)
  // find the effect of direct additions to the result R+
  r_plus.add(q(e.steps(i+1,e.size( )), plus,document));
  // find the effect of direct deletions to the result R−
  foreach Path p in rp (
    if(deletion.includes(p.nodeAt(i)))
        r_minus.add(p.resultNode( ));
      }
  }
  candidate = candidate1; // Cᵢ′
}
result.add(r_plus);
result.remove(r_minus);
  return result;
}
boolean predBefore(Node n, Expression e, int i, Document d,
ResultPath rp) {
  if(n.update_type == ‘add’) {
    return false;
  } else if(e.step(i).pred == null) {
    return true;
  } else {
    return rp.includesAt(i,n);
  }
}
boolean predAfter(Node n, Expression e, int i, Document d) {
  if(n.update_type == ‘delete’) {
    return false;
  } else if(e.step(i).pred == null) {
    return true;
  } else {
    return predq(e.step(i).pred,n,d);
  }
}
```

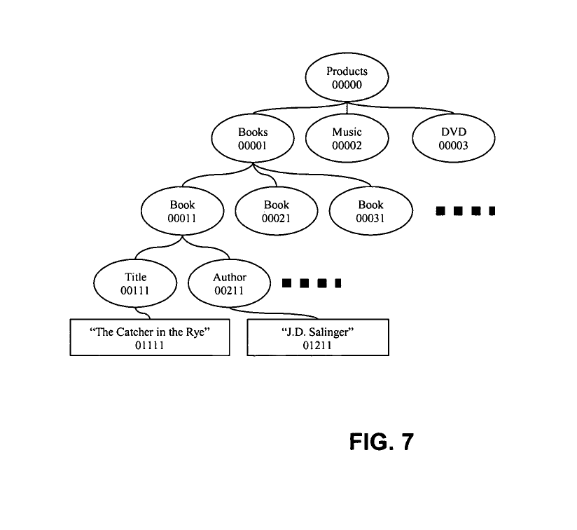

FIG. 7 shows an exemplary XML tree illustrating an incremental maintenance example. In this example, the sample XML data is as follows:

```
<Products>
  <Books>
    <Book>
      <Title>The Catcher in the Rye</Title>
      <Author>J.D. Salinger</Author>
    <Year>1991</Year>
    <Publisher>Little,Brown<Publisher>
    <ISBN>0316769487</ISBN>
    <Subject>Fiction</Subject>
    <Subject>Classics</Subject>
    <Seller id=“http://bookstore1.com”>
      <Name>BookStoreOne</Name>
      <Rating>4</Rating>
      <Price>6.99</Price>
      <Availability>true<Availability>
    <Seller id=“http://bookstore2.com”>
      <Name>BookStoreTwo</Name>
      <Rating>3</Rating>
      <Price>5.99</Price>
      <Availability>true</Availability>
    </Seller>
  </Book>
  <Book>
    <Title>Nine Stories</Title>
    <Author>J.D. Salinger</Author>
    <Year>1991</Year>
    <Publisher>Little,Brown<Publisher>
    <ISBN>0316769509</ISBN>
    <Subject>Fiction</Subject>
    <Subject>Classics</Subject>
    <Seller id=“http://bookstore2.com”>
      <Name>BookStoreTwo</Name>
      <Rating>3</Rating>
      <Price>5.99</Price>
      <Availability>true</Availability>
    </Seller>
    </Book>
    <Book>
    <Title>Franny and Zooey</Title>
    <Author>J.D. Salinger</Author>
    <Year>1991</Year>
    <Publisher>Little,Brown<Publisher>
    <ISBN>0316769495</ISBN>
    ....
    </Book>
    ....
  </Books>
  <Music>...</Music>
  <DVD>...</DVD>
</Products>
```

The following example, together with the nodes of FIG. 7, illustrates a query for a book written by Salinger and the price is less then $6. The result set is “The Catcher in the Rye” at node₀₁₁₁₁, “Nine Stories” at node₀₁₁₂₁, “Franny and Zooey” at node₀₁₁₃₁. The result path is shown as RP₁.

### EXAMPLE 1

Q₁ = //Book[Author = ‘J.D. Salinger’ and /Seller/Price < 6]/Title/text( )
R₁ = {“The Catcher in the Rye”₀₁₁₁₁, “Nine Stories”₀₁₁₂₁, “Franny and
Zooey”₀₁₁₃₁}
RP₁ = [[00011,00111,01111],[00021,00121,01121],[00031,00131,01131]]

In example 1-1, an update changes the price for node 04812 from $10 to $12 and result set does not change as follows:

### EXAMPLE 1-1

U₁ = /Products₀₀₀₀₀/Music₀₀₀₀₂/CD₀₀₀₁₂/Seller₀₀₈₁₂/Price₀₄₈₁₂/
{“10”,“12”}₁₄₈₁₂
C₀ = {Products₀₀₀₀₀}
C₁ = q(//Book,C₀,U₁) = { }
Since the candidate set Cᵢ is empty the loop stops at the step i = 1.
There is no change in the result R₁.

In example 1-2, another update changes the price from $5.99 to $6.99 and the result set becomes “The Catcher in the Rye”₀₁₁₁₁, “Franny and Zooey”₀₁₁₃₁

### EXAMPLE 1-2

U₂ = /Products₀₀₀₀₀/Books₀₀₀₀₁/Book₀₀₀₂₁/Seller₀₀₈₂₁/Price₀₄₈₂₁/
{“5.99”,“6.99”}₁₄₈₂₁
C₀ = {Products₀₀₀₀₀}
C₁ = q(//Book,C₀,U₂) = {Book₀₀₀₂₁}
For each node in C₁, the following predicate is checked:
Q1.step(1).pred= [Author = ‘J.D. Salinger’ and /Seller/Price < 6]
The result is as follows:
Pred₁^{before}(Book₀₀₀₂₁) = true (it is in the result path RP₁)
Pred₁^{after}(Book₀₀₀₂₁) = false (query to the source)
Accordingly, direct additions and deletions found at the step 1 are:
Add₁ = { }, Del₁ = {Book₀₀₀₂₁}.
This causes the following deletion in the result
R⁻ = {“Nine Stories”₀₁₁₂₁}
Since C₁′ is empty, the loop stops here.
Finally, the result set is updated as:
R₁′ = {“The Catcher in the Rye”₀₁₁₁₁, “Franny and Zooey”₀₁₁₃₁}

In Example 1-3, another update changes the price from $6.99 to $5.99 and the result set in this case does not change.

### EXAMPLE 1-3

U₃ = /Products₀₀₀₀₀/Books₀₀₀₀₁/Book₀₀₀₁₁/Seller₀₀₈₁₁/Price₀₄₈₁₁/
{“6.99”,“5.99”}₁₄₈₁₁
C₀ = {Products₀₀₀₀₀}
C₁ = q(//Book,C₀,U₃) = {Book₀₀₀₁₁}
For each node in C₁, the following predicate is checked:
Q1.step(1).pred= [Author = ‘J.D. Salinger’ and /Seller/Price < 6]
The result is as follows:
Pred₁^{before}(Book₀₀₀₁₁) = true (it was in the result path)
Pred₁^{after}(Book₀₀₀₁₁) = true (query to the source)
Thus, there is no direct addition/deletion found at the step i = 1.
Since C₁′ = {Book₀₀₀₁₁}, the loop proceeds to the step 2 resulting:
C₂ = q(/Title,{Book₀₀₀₁₁},U₃) = { }
The loop stops here since the candidate set is empty. There is no
change in the result R₁.

Similarly, Examples 2, 2-1 and 2—are as follows:

### EXAMPLE 2

Q₂ = //Book[ISBN=0316769487]/Seller[Rating > 3]/Price/text( )
R₂ = {“6.99”₁₄₈₁₁}
RP₂ = [[00011,00811,04811,14811]]

### EXAMPLE 2-1

```
U₁ = /Products₀₀₀₀₀/Music₀₀₀₀₂/CD₀₀₀₁₂/Seller₀₀₈₂₁₂/Price₀₄₈₁₂/
{“10”,“12”}₁₄₈₁₂
    C₀ = {Products₀₀₀₀₀}
    C₁ = q(//Book,C₀,U₁) = { }
    Since the candidate set Cᵢ is empty the loop stops at the step i = 1.
    There is no change in the result R₂.
```

### EXAMPLE 2-2

U₂ = /Products₀₀₀₀₀/Books₀₀₀₀₁/Book₀₀₀₂₁/Seller₀₀₈₂₁/Price₀₄₈₂₁/
{“5.99”,“6.99”}₁₄₈₂₁
C₀ = {Products₀₀₀₀₀}
C₁ = q(//Book,C₀,U₂) = {Book₀₀₀₂₁}
For each node in C₁, the following predicate is checked:
Q₂.step(1).pred = [ISBN=0316769487]
Pred₁^{before}(Book₀₀₀₂₁) = false (it is NOT in the result path RP₂)
Pred₁^{after}(Book₀₀₀₂₁) = false (query to the source)
Here, there is no direct addition/deletion found at the step i = 1.
Since C₁′ is empty, the loop stops here. There is no change
in the result set R₂.

### EXAMPLE 2-3

U₃ = /Products₀₀₀₀₀/Books₀₀₀₀₁/Book₀₀₀₁₁/Seller₀₀₈₁₁/Price₀₄₈₁₁/
{“6.99”,“5.99”}₁₄₈₁₁
C₀ = {Products₀₀₀₀₀}
C₁ = q(//Book,C₀,U₃) = {Book₀₀₀₁₁}
For each node in C₁, the following predicate is checked:
Q₂.step(1).pred = [ISBN=0316769487]
Pred₁^{before}(Book₀₀₀₁₁) = true (it was in the result path)
Pred₁^{after}(Book₀₀₀₁₁) = true (query to the source)
There is no direct addition/deletion found at the step 1. Since C₁′ =
{Book₀₀₀₁₁}, the loop proceeds to the step 2:
C₂ = q(/Seller,{Book₀₀₀₁₁},U₃) = { Seller₀₀₈₁₁}
For each node in C₂, the following predicate is checked:
Q₂.step(2).pred = [Rating > 3]
Pred₂^{before}(Seller₀₀₈₁₁) = true (it was in the result path)
Pred₂^{after}(Seller₀₀₈₁₁) = true (query to the source)
There is no direct addition/deletion found at the step 2. Since C₂′ =
{Seller₀₀₈₁₁}, the loop proceeds to the step 3:
C₃ = q(/Price,{ Seller₀₀₈₁₁},U₃) = {Price₀₄₈₁₁}
For each node in C₃, the predicate check is done (note that there is no
predicate at the step 3):
Pred₃^{before}(Price₀₄₈₁₁) = true (it was in the result path)
Pred₃^{after}(Price₀₄₈₁₁) = true (no predicate)
There is no direct addition/deletion found at the step 3. Since C₃′ =
{Price₀₄₈₁₁}, the loop proceeds to the step 4:
C₄ = q(text( ), {Price₀₄₈₁₁},U₃) = {−“6.99”₁₄₈₁₁,+“5.99”₁₄₈₁₁}
For each node in C₄, the predicate check is done:
Pred₄^{before}(−“6.99”₁₄₈₁₁) = true (it was in the result path)
Pred₄^{after}(−“6.99”₁₄₈₁₁) = true (node.update_type = ‘delete’)
Pred₄^{before}(+“5.99”₁₄₈₁₁) = false (it is deleted)
Pred₄^{after}(+“5.99”₁₄₈₁₁) = true (node.update_type = ‘add’)
Here direct addition and deletion are found:
Add₄ = {“5.99”₁₄₈₁₁}, Del₄ = {“6.99”₁₄₈₁₁}
Since this is the last step,
R⁺ = {“5.99”₁₄₈₁₁}, R⁻ = {“6.99”₁₄₈₁₁₁}
The result set is updated as: R₂ = {“6.99”₁₄₈₁₁}

Although the foregoing has focused on processing the two primitive update operations of adding and deleting leaf nodes, it can be more efficient to handle a complex update, such as adding or deleting subtrees, holistically rather than by decomposing it into the primitive operations. The process for the primitive updates can be extended to handle the complex updates of adding or deleting subtrees. In this case, the U.path becomes a branch that ends with a subtree from the last node, this is the added or deleted subtree. The direct effects can be determined by applying the Axis&Label test and the Predicates test on this branch. Once the direct effects are discovered, the indirect ones can be discovered in the same way as described above.

Generally, source updates may occur simultaneously with the view maintenance process. Consider this scenario, an update U₁ occurs and is reported to the cache manager, thus, the cache manager initiates a view maintenance process to update the cached views according to U₁. At this time a new update U₂ occurs at the source before the source query processor processes the queries which the maintenance process of U₁ is using to maintain the views. In this case, processing these queries at the source will include the effects of U₂ as well as those of U₁. Then when U₂ is reported to the cache manager, a new maintenance process will be initiated to maintain the views according to U₂. This second maintenance process will typically need to issue queries to the source to maintain the views. However, this second maintenance process could take advantage of the fact that the effect of U₂ has already been incorporated in the answers of the queries that were issued in response to U₁. If such cases are detected, the view maintenance process could be made more efficient by reducing the number of source queries used to maintain the views. One embodiment to detect such cases is to use time-stamps for all the updates and the query answers received from the source; with that, the cache manager can determine which update effects have been incorporated in which answers. Caching systems normally cache the results of multiple expressions. Upon receiving an update U the presented maintenance algorithm can be run to maintain every expression separately. However, if many of these expressions have significant overlap in their structure, the process can maintain such collections collectively to improve efficiency. For example, efficiency can be gained by evaluating the predicates without source queries.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the foregoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

What is claimed is:

1. A process for providing view maintenance, comprising:
buffering one or more search results in a cache; and
incrementally maintaining the search results by analyzing a source data update and updating the cache based on a relevance of the update to the search results.

2. The process of claim 1, wherein the source data is structured data.

3. The process of claim 1, wherein the source data is XML (extensible mark-up language) data.

4. The process of claim 1, comprising determining one or more direct effects of an addition or a deletion to the source data.

5. The process of claim 4, comprising determining one or more indirect effects based on the determined direct effects.

6. The process of claim 1, comprising applying an axes and labels test to identify a sequence Δᵢ.

7. The process of claim 6, comprising:
applying a predicate test to determine a sequence of direct effects δᵢ; and
updating the search results based on the sequence of direct effects δᵢ.

8. The process of claim 6, wherein the sequence Δᵢ comprises a supersequence of a sequence of direct effects δᵢ.

9. The process of claim 6, comprising determining Δᵢ as all the nodes in a search path that satisfy the axis and the label starting at nodes in Δᵢ₋₁.

10. The process of claim 1, comprising determining a node n in Δᵢ with a changed Predᵢ(n).

11. A method to maintain a materialized view R, comprising:
determining a sequence Δᵢ by applying an axis test and a label test for each step sᵢ starting at one or more nodes of a sequence Δᵢ₋₁;
determining a sequence of direct effects δᵢ by applying a predicate test of sᵢ to nodes of Δᵢ;
applying δᵢ to find one or more indirect effects on R; and
updating R.

12. The method of claim 11, wherein the axis test selects nodes based on a tree structure.

13. The method of claim 11, wherein the label test comprises a selection condition in a query involving one of: a node name, a node kind, and a node type.

14. The method of claim 11, comprising updating source data.

15. The method of claim 14, wherein the source data comprises extensible mark-up language (XML) data.

16. The method of claim 11, wherein applying the predicate test comprises determining Δᵢ as all the nodes in a search path that satisfy the axis and the label starting at nodes in Δᵢ₋₁.

17. The method of claim 11, comprising determining changes in a predicate due to an update.

18. The method of claim 17, comprising determining values for the predicate before and after the update.

19. The method of claim 11, comprising determining a predicate value by querying a source data.

20. The method of claim 11, comprising starting only an iteration i at the nodes of a previous iteration for which a previous predicate value is true before and after an update.
